(19) United States
(12) Patent Application Publication
(10) Pub. No.: US 2026/0011326 A1
(43) Pub. Date: Jan. 8, 2026

(54) TRANSDUCER CONSISTENCY REGULARIZATION FOR SPEECH-TO-TEXT APPLICATIONS

(71) Applicant: Samsung Electronics Co., Ltd., Suwon-si (KR)

(72) Inventors: Cindy Sushen Tseng, Santa Clara, CA (US); Yun Tang, Fremont, CA (US); Divya Neelagiri, Dublin, CA (US); Euisung Kim, Mountain View, CA (US)

(21) Appl. No.: 19/197,840

(22) Filed: May 2, 2025

Related U.S. Application Data
(60) Provisional application No. 63/667,647, filed on Jul. 3, 2024.

(51) Int. Cl. G10L 15/197; G10L 15/02; G10L 15/06

(52) U.S. Cl. CPC G10L 15/197; G10L 15/02; G10L 15/063; G10L 2015/0635

(57) ABSTRACT

A method includes receiving an audio input and providing the audio input to a transducer model. The method also includes predicting, using the transducer model, text associated with the audio input and outputting the predicted text. The transducer model is trained using a training dataset that includes samples including audio frames and a ground truth subword unit transcription. A first view of a training sample is generated by adding first random noise to the audio frames. A second view of the training sample is generated by adding second random noise to the audio frames. The first view and the second view are provided to the transducer model. The transducer model predicts a probability distribution for each of the first view and the second view. The probability distribution includes probabilities of possible frame synchronization decoding between the audio frames and transcriptions. The transducer model is modified based on a transducer loss.

### CROSS-REFERENCE TO RELATED APPLICATION AND PRIORITY CLAIM

This application claims priority under 35 U.S.C. § 119 (e) to U.S. Provisional Patent Application No. 63/667,647 filed on Jul. 3, 2024, which is hereby incorporated by reference in its entirety.

### TECHNICAL FIELD

This disclosure relates generally to machine learning systems and processes. More specifically, this disclosure relates to transducer consistency regularization for speech-to-text applications.

### BACKGROUND

Consistency regularization is an approach for learning how to generate consistent representations of input features with different views or from different models via minimizing a distribution difference. Consistency regularization is used in self-supervised learning and semi-supervised learning to stabilize training and alleviate data perturbation sensitivity. Studies have shown consistency learning is beneficial for speech-to-text tasks, although such studies are limited to certain frameworks and are only optimized with cross entropy loss.

### SUMMARY

This disclosure relates to transducer consistency regularization for speech-to-text applications.

In a first embodiment, a method includes receiving, via an audio input device, an audio input. The method also includes providing the audio input to a transducer model and predicting, using the transducer model, text associated with the audio input. The method further includes outputting the predicted text. The transducer model is trained using a training dataset, where samples in the training dataset include audio frames and a ground truth subword unit transcription. A first view of a training sample is generated by adding first random noise to the audio frames. A second view of the training sample is generated by adding second random noise to the audio frames. The first view and the second view are provided to the transducer model. The transducer model predicts a probability distribution for each of the first view and the second view, where the probability distribution includes probabilities of possible frame synchronization decoding between the audio frames and transcriptions. The transducer model is modified based on a transducer loss.

In a second embodiment, an electronic device includes at least one processing device configured to receive, via an audio input device, an audio input. The at least one processing device is also configured to provide the audio input to a transducer model and predict, using the transducer model, text associated with the audio input. The at least one processing device is further configured to output the predicted text. The transducer model is trained using a training dataset, where samples in the training dataset include audio frames and a ground truth subword unit transcription. A first view of a training sample is generated by adding first random noise to the audio frames. A second view of the training sample is generated by adding second random noise to the audio frames. The first view and the second view are provided to the transducer model. The transducer model predicts a probability distribution for each of the first view and the second view, where the probability distribution includes probabilities of possible frame synchronization decoding between the audio frames and transcriptions. The transducer model is modified based on a transducer loss.

In a third embodiment, a non-transitory machine-readable medium includes instructions that when executed by at least one processor cause an electronic device to receive, via an audio input device, an audio input. The non-transitory machine-readable medium also includes instructions that when executed by the at least one processor cause the electronic device to provide the audio input to a transducer model and predict, using the transducer model, text associated with the audio input. The non-transitory machine-readable medium further includes instructions that when executed by the at least one processor cause the electronic device to output the predicted text. The transducer model is trained using a training dataset, where samples in the training dataset include audio frames and a ground truth subword unit transcription. A first view of a training sample is generated by adding first random noise to the audio frames. A second view of the training sample is generated by adding second random noise to the audio frames. The first view and the second view are provided to the transducer model. The transducer model predicts a probability distribution for each of the first view and the second view, where the probability distribution includes probabilities of possible frame synchronization decoding between the audio frames and transcriptions. The transducer model is modified based on a transducer loss.

Any single one or any combination of the following features may be used with the first, second, or third embodiments. The transducer model may be modified based on the transducer loss via an application of a first transducer divergence loss, and the first view may be treated as a teacher and the second view may be treated as a student. The transducer model may be modified based on the transducer loss via an application of a second transducer divergence loss, and the second view may be used as the teacher and the first view may be used as the student. Each possible frame synchronization decoding may correspond to a sequence of token predictions for the audio frames, and a token prediction for a given audio frame may be either a transcript token or a blank token. A weighted sum of the first transducer divergence loss and the second transducer divergence loss may be used during training, and weights of the weighted sum may be dependent upon how much each probability distribution contributes to the transducer loss. The transducer model may include an encoder, a predictor, and a joiner. The encoder may encode the audio input into an audio feature vector. The predictor may receive previous tokens to predict a subsequent token. The joiner may combine the audio feature vector and the subsequent token to output the probability distribution.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112 (f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112 (f).

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example network configuration including an electronic device in accordance with this disclosure;

FIG. 2 illustrates an example speech-to-text system in accordance with this disclosure;

FIG. 3 illustrates an example transducer model architecture in accordance with this disclosure;

FIG. 4 illustrates an example transducer decoding lattice in accordance with this disclosure;

FIG. 5 illustrates an example transducer model training process in accordance with this disclosure;

FIG. 6 illustrates an example method for training a transducer model in accordance with this disclosure; and

FIG. 7 illustrates an example method for performing a speech-to-text task using a transducer model in accordance with this disclosure.

### DETAILED DESCRIPTION

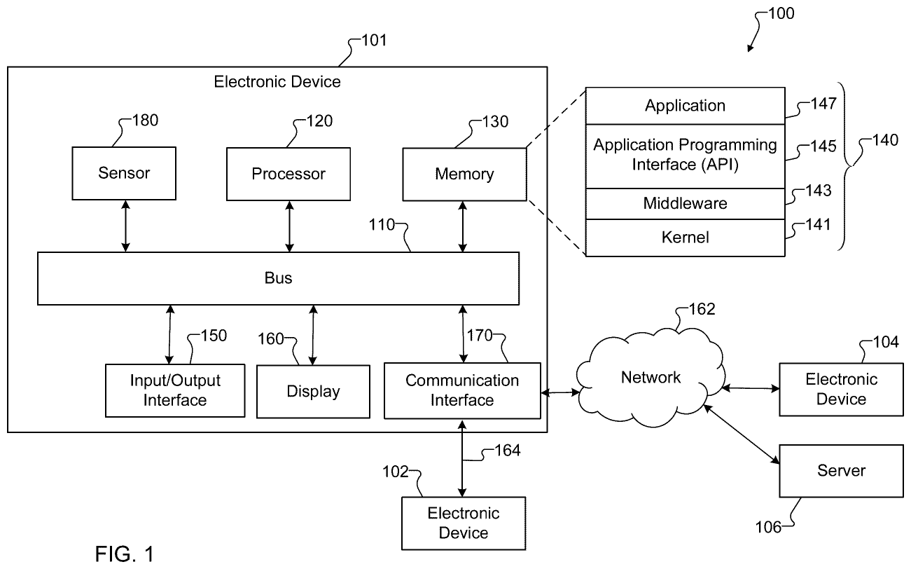

FIGS. 1 through 7, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, consistency regularization is an approach for learning how to generate consistent representations of input features with different views or from different models via minimizing a distribution difference. Consistency regularization is used in self-supervised learning and semi-supervised learning to stabilize training and alleviate data perturbation sensitivity. Studies have shown consistency learning is beneficial for speech-to-text tasks, although such studies are limited to certain frameworks and are only optimized with cross entropy loss.

Consistency regularization is a desirable property for speech-to-text tasks since speech data contains different kinds of variations, such as channel variability, speaker variability, background noise, etc. Various embodiments of this disclosure use a transducer model to perform speech-to-text conversions. Transducer models were first introduced to transform any input sequence into another finite, discrete output sequence and have been adopted in automatic speech recognition (ASR) due to good performance and good support for both streaming and offline decoding modes. As described in this disclosure, transducer models can achieve very competitive results on other challenge tasks, such as speech-to-text translation (ST), which is a non-monotonic alignment task, and text-to-speech synthesis (TTS), which can have a longer target sequence than the input sequence. However, applying consistency regularization for transducer-based modeling is not straightforward due to the complexity of output distributions. In transducer optimization, the model would consider all potential alignments among input and output sequences, but not all alignments are practical for speech-to-text operations given that the input and output sequences and the distributions from those alignments could be far from the desirable distributions expected. Consistency regularization on those distributions could even decrease model performance.

This disclosure provides for training a transducer model for speech-to-text operations and provides for use of the trained transducer model in performing speech-to-text operations on an electronic device. In various embodiments, the transducer model can include a speech encoder that converts audio frames into an audio feature vector, a predictor that takes previous tokens generated based on the audio feature vector and predicts what the next token in the sequence should be, and a joiner that combines the audio feature vector with the predicted token and produces a probability distribution representing the likelihood of different possible outcomes for a next token in the sequence.

The transducer model can be trained using a training dataset that includes samples having audio frames and a ground truth subword unit transcription. Using the training dataset, a first view of a training sample can be generated by adding first random noise to the audio frames, and a second view of the training sample can be generated by adding second random noise to the audio frames. The first view and the second view can be provided to the transducer model, and the transducer model can predict a probability distribution for each of the first view and the second view. The probability distribution can include probabilities of possible frame synchronization decoding between the audio frames and transcriptions, and the transducer model can be modified based on a transducer loss.

Note that while some of the embodiments discussed below are described in the context of use in consumer electronic devices (such as smartphones), this is merely one example. It will be understood that the principles of this disclosure may be implemented in any number of other suitable contexts and may use any suitable device or devices. Also note that while some of the embodiments discussed below may be described based on the assumption that one device (such as a server) performs training of a machine learning model that is deployed to one or more other devices (such as one or more consumer electronic devices), this is also merely one example. It will be understood that the principles of this disclosure may be implemented using any number of devices, including a single device that both trains and uses a machine learning model. In general, this disclosure is not limited to use with any specific type(s) of device(s).

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), or a graphics processor unit (GPU). The processor 120 is able to perform control on at least one of the other components of the electronic device 101 and/or perform an operation or data processing relating to communication or other functions. As described in more detail below, the processor 120 may perform various operations related to transducer consistency regularization for speech-to-text applications.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may support various functions related to transducer consistency regularization for speech-to-text applications. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, one or more sensors 180 can include one or more cameras or other imaging sensors for capturing images of scenes. The sensor(s) 180 can also include one or more buttons for touch input, one or more microphones, a gesture sensor, a gyroscope or gyro sensor, an air pressure sensor, a magnetic sensor or magnetometer, an acceleration sensor or accelerometer, a grip sensor, a proximity sensor, a color sensor (such as an RGB sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the first external electronic device 102 or the second external electronic device 104 can be a wearable device or an electronic device-mountable wearable device (such as an HMD). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network. The electronic device 101 can also be an augmented reality wearable device, such as eyeglasses, that include one or more imaging sensors.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described in more detail below, the server 106 may perform various operations related to transducer consistency regularization for speech-to-text applications.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

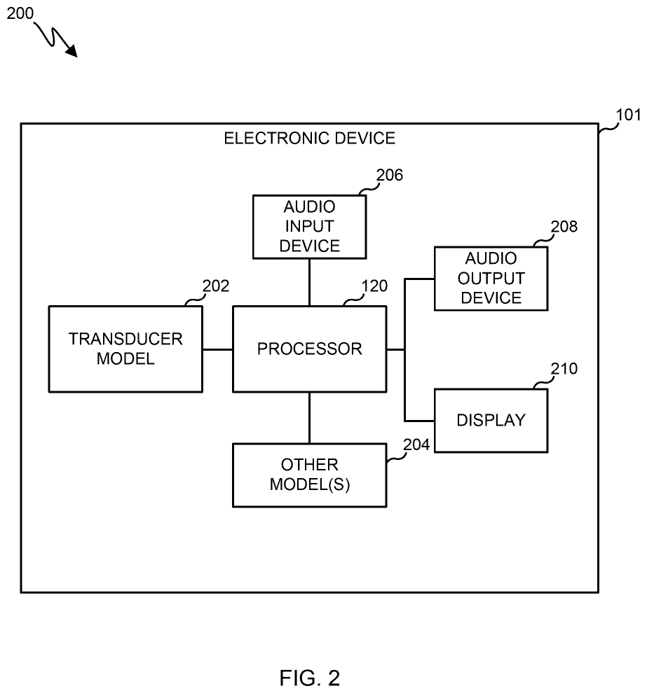

FIG. 2 illustrates an example speech-to-text system 200 in accordance with this disclosure. For case of explanation, the system 200 is described as involving the use of the electronic device 101 in the network configuration 100 of FIG. 1. However, the system 200 may be used with any other suitable electronic device(s), such as the server 106, and in any other suitable system(s).

As shown in FIG. 2, the system 200 includes the electronic device 101, which includes the processor 120. The processor 120 is operatively coupled to or otherwise configured to use one or more machine learning models, such as a transducer model 202. The transducer model 202 can be trained to take audio data as input and perform speech-to-text operations to create one or more text transcriptions corresponding to the audio data.

The processor 120 can also be operatively coupled to or otherwise configured to use one or more other machine learning models 204, such as one or more personal assistant, automated speech recognition (ASR), and/or natural language understanding (NLU) models. It will be understood that the machine learning models can be stored in a memory of the electronic device 101 (such as the memory 130) and accessed by the processor 120 to perform speech-to-text or other tasks. However, the machine learning models can be stored in any other suitable manner.

The system 200 also includes an audio input device 206 (such as a microphone), an audio output device 208 (such as a speaker or headphones), and a display 210 (such as a screen or a monitor like the display 160). The processor 120 can receive an audio input from the audio input device 206 and provides the audio input to the transducer model 202. The transducer model 202 can convert audio frames from the audio input into audio feature vectors, generate tokens based on the audio feature vector, predict one or more additional tokens, and combine the audio feature vector and the predicted token(s) to create a probability distribution representing a likelihood of different possible outcomes for a next token for the audio data. This process serves to convert the input audio into a text representation that can be used, such as by one of the other models 204, to perform one or more tasks.

As a particular example, assume an utterance is received from a user via the audio input device 206, such as “hey BIXBY, call mom.” Here, the transducer model 202 converts the audio input into a textual representation, and the textual representation can be used, such as by the other models 204, to determine a task to be performed by the electronic device 101. In this case, for instance, this can cause the processor 120 to instruct the audio output device 208 to output “calling Mom,” and the processor 120 can also cause a phone application or other communication application to begin a communication session with a “mom” contact stored on the electronic device 101 or otherwise in association with the user of the electronic device 101. As another particular example, suppose an utterance of “hey BIXBY, start a timer” is received. In such an example, the transducer model 202 can convert the audio data into a textual representation. Using the textual representation and possibly one or more of the other models 204, the processor 120 may instruct execution of a timer application and display of a timer on the display 210 of the electronic device 101.

Although FIG. 2 illustrates one example of a speech-to-text system 200, various changes may be made to FIG. 2. For example, the audio input device 206, the audio output device 208, and the display 210 can be connected to the processor 120 within the electronic device 101, such as via wired connections or circuitry. In other embodiments, the audio input device 206, the audio output device 208, and the display 210 can be external to the electronic device 101 and connected via wired or wireless connections. Also, in some cases, the transducer model 202, as well as one or more of the other machine learning models 204, can be stored as separate models called upon by the processor 120 to perform certain tasks or can be included in and form a part of one or more larger machine learning models. Further, in some embodiments, one or more of the machine learning models, including the transducer model 202 and one or more of the other machine learning models 204, can be stored remotely from the electronic device 101, such as on the server 106. Here, the electronic device 101 can transmit requests including inputs (such as captured audio data) to the server 106 for processing of the inputs using the machine learning models, and the results can be sent back to the electronic device 101. In addition, in some embodiments, the electronic device 101 can be replaced by the server 106, which can receive audio inputs from a client device and transmit instructions back to the client device to execute functions associated with instructions included in utterances.

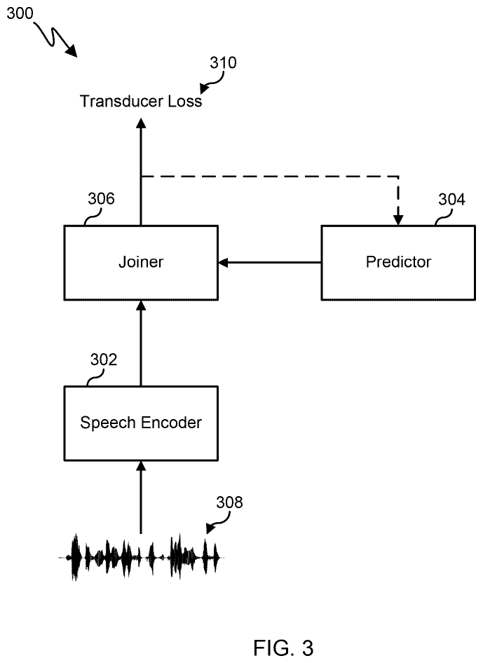

FIG. 3 illustrates an example transducer model architecture 300 in accordance with this disclosure. For ease of explanation, the architecture 300 shown in FIG. 3 is described as being implemented on or supported by the electronic device 101 in the network configuration 100 of FIG. 1. However, the architecture 300 shown in FIG. 3 could be used with any other suitable device(s) and in any other suitable system(s), such as when the architecture 300 is implemented on or supported by the server 106. In some cases, the architecture 300 can represent or be a part of the transducer model 202 descried with respect to FIG. 2.

As shown in FIG. 3, the transducer model architecture 300 include a speech encoder 302, a predictor 304, and a joiner 306. The speech encoder 302 receives audio data 308 and transforms the audio data 308 into a hidden audio representation. For example, the speech encoder 302 can convert one or more audio frames of the audio data 308 into an audio feature vector, such as by taking the raw audio data and extracting important information from the raw audio data. The audio feature vector can be used by the architecture 300 for generating predictions.

The predictor 304 receives a previous token and predicts a hidden text representation. For example, the predictor 304 can take previous tokens generated based on the audio feature vector and predict what the next token should be. By using this approach, the transducer model can generate accurate predictions concerning upcoming audio content. The joiner 306 uses the hidden audio representation and the hidden text representation to predict a current token. For example, the joiner 306 can combine the audio feature vector with the predicted token and produce a probability distribution. This probability distribution represents the likelihood of different possible outcomes for the next token. Overall, the speech encoder 302, the predictor 304, and the joiner 306 work together seamlessly to create an efficient and effective transducer model for processing audio data. The architecture 300 can be used to output text predictions corresponding to the audio data 308.

In various embodiments, the speech encoder 302 can be a recurrent neural network (RNN), a convolutional neural network (CNN), a transformer network, etc. Also, in various embodiments, the predictor 304 can be a prediction network decoder such as a recurrent neural network like a long short-term memory (LSTM) decoder, a gated recurrent units (GRU) decoder, or a transformer decoder. Unlike traditional sequence-to-sequence models, the predictor 304 may operate at the output level, meaning it predicts tokens one by one. In addition, in various embodiments, the joiner 306 can be a joint network that outputs the final sequence of tokens by jointly considering both the acoustic information from the speech encoder 302 and the predicted output context from the predictor 304.

As also shown in FIG. 3, during training of the transducer model, a transducer loss 310 can be obtained. To train the transducer model, a training dataset can be used that includes audio recordings and corresponding subword unit transcriptions. In some cases, two different versions of each training example can be generated by adding random noise to the audio frames. These versions or “views” are provided to the transducer model, which calculates the likelihood of various alignments between the audio frames and the transcripts. The transducer model predicts a probability distribution for each of the different views, where the probability distribution includes probabilities of possible frame synchronization decoding between the audio frames and transcriptions. The process of frame synchronization decoding involves generating a sequence of predicted tokens for T audio frames. Each token prediction can either be a transcript token or a blank token.

In some embodiments, the transducer loss used to train the transducer model can include a combination of two types of losses. The two types of losses can include a first transducer Kullback-Leibler (KL) divergence loss, where a first view of the different views is considered the “teacher” and a second view is considered the “student.” The two types of losses can also include a second transducer KL divergence loss with the roles reversed, where the first view of the different views is considered the “student” and a second view is considered the “teacher.” KL divergence loss is a measure of a statistical distance, meaning the measure of how much a model probability distribution Q is different from a true probability distribution P. This approach allows for the transducer model to effectively learn from multiple noisy versions of the same data. The first transducer KL divergence loss and the second transducer KL divergence loss can be weighted based on their contributions to the overall transducer loss. Training the transducer model in this way has been found to produce more accurate results than other approaches.

Using a transducer model, including the architecture 300, for speech-to-text and text-to-speech can have various advantages depending on the implementation. For example, if a user is using the electronic device 101 for voice commands, the electronic device 101 can benefit from being able to understand what the user is saying and to respond quickly. This involves two main tasks: recognizing what the user said (speech-to-text) and saying something back to the user (text-to-speech). The transducer model acts like a translator to help the electronic device 101 convert the user speech into words (text) and, if needed, turn those words back into speech. Existing approaches for speech-to-text could break this process into several steps, like figuring out the sounds the user is making, matching them to words, and processing those words to understand the user, which tends to be time extensive. The various embodiments of this disclosure, however, provide for using a transducer model that performs all of this in one smooth step. The transducer model listens to the user's voice and directly translates user speech into text as the user speaks, which is especially useful for tasks like live conversations or commands. The transducer model can also perform text-to-speech by taking a generated text response to user speech and turning it into speech that sounds natural and smooth by determining the right tone, emphasis, and pauses to make the speech sound like a real person, instead of a robotic voice.

The transducer model of this disclosure processes tasks quickly, including performing speech-to-text as a user speaks, making applications like voice assistants or live subtitles very responsive while also maintaining high accuracy by handling everything at once, reducing mistakes that can happen when speech is processed in separate steps. The transducer model operates by aligning an input sequence with an output sequence dynamically, which can be particularly useful for ASR and speech-to-text tasks in which the length of the input (audio) and output (text) can vary significantly. Unlike traditional models that rely on external alignment techniques like Hidden Markov Models (HMMs) or Connectionist Temporal Classification (CTC), the transducer model performs alignment internally to provide for dynamic alignment. It can predict both “blank” tokens (which skip over input frames) and actual output symbols (such as text characters or words). This allows the transducer model to handle situations where the input and output lengths do not correspond directly. One possible significant advantage of the transducer model is its ability to process streaming inputs. Since the transducer model does not need the entire input sequence beforehand, the transducer model can generate outputs (such as text) incrementally as more audio becomes available, making it suitable for real-time applications.

In various embodiments, during ASR tasks, the transducer model can process an audio signal and convert the audio signal directly into text. In ASR tasks, the speech encoder 302 processes the raw acoustic features (such as Mel-spectrogram or Mel-Frequency Cepstral Coefficients (MFCC) features) and generates a high-level sequence of hidden states representing the speech signal. The predictor 304 generates hypotheses for the next token in the output text based on previous tokens (or blank predictions). The joiner 306 takes the representations from the speech encoder 302 and the predictor 304, combining them to output a probability distribution over possible output symbols at each time step. In some cases, the transducer model can be trained using forward-backward algorithms, optimizing over all possible alignments between the input and output.

In various embodiments, during speech-to-text translation tasks, the transducer model can be extended to directly map audio in one language to text in another language. Here, the transducer model may work similarly to ASR transducers but can be trained with bilingual data, where the input is speech in one language and the output is text in another language. However, the predictor 304 here can generate tokens in the target language instead of the source language, which adds complexity due to the non-monotonic alignment between speech and translated text.

In text-to-speech synthesis (TTS) tasks, the transducer model can be used to convert a textual input into a sequence of Mel-spectrogram frames, which can be converted into speech waveforms using a vocoder (such as WaveNet or WaveGlow). Here, the speech encoder 302 can convert the input text into hidden representations, and the predictor 304 can predict the Mel-spectrogram sequence. In some embodiments, attention mechanisms can be used to align the input text with the output speech.

In some embodiments, the transducer model can be trained end-to-end, meaning the transducer model can be optimized directly for the task of interest (such as speech-to-text or text-to-speech) without the need for intermediate steps like acoustic modeling or language modeling in ASR. Also, the transducer model may allow for streaming and low latency, making the transducer model particularly suited for real-time applications, as the transducer model can process input incrementally and produce output as soon as sufficient data is available. The transducer model can also provide for internal alignment. By allowing “blank” predictions, the transducer can handle variable-length alignment between inputs (such as speech) and outputs (such as text) internally, without relying on external forced alignment tools like hidden Markov models (HMMs) or alignment models in CTC.

Although FIG. 3 illustrates one example of a transducer model architecture 300, various changes may be made to FIG. 3. For example, various components and functions in FIG. 3 may be combined, further subdivided, replicated, rearranged, or omitted according to particular needs. Also, one or more additional components and functions may be included if needed or desired.

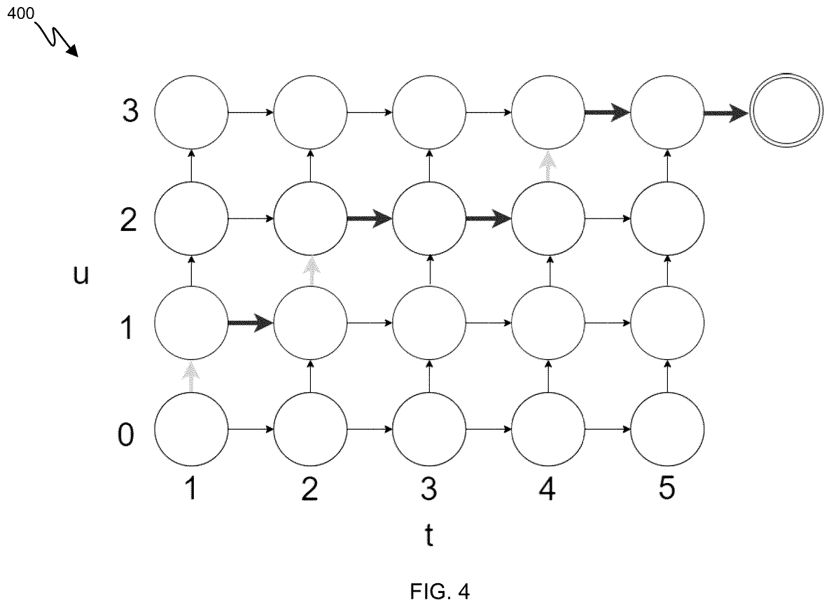

FIG. 4 illustrates an example transducer decoding lattice 400 in accordance with this disclosure. For case of explanation, the transducer decoding lattice 400 is described as involving the use of the electronic device 101 in the network configuration 100 of FIG. 1 and the transducer model 202 of FIG. 2. However, the transducer decoding lattice 400 may be used with any other suitable electronic device (such as the server 106) or a combination of devices (such as the electronic device 101 and the server 106) and in any other suitable system(s).

As shown in FIG. 4, the transducer decoding lattice 400 can represent frame synchronization-based decoding performed by a transducer model, such as the transducer model 202. The lattice 400 includes an input sequence along an x axis and an output target sequence along a y axis. Specifically, let x_{1:T}=(x₁, x₂, . . . , x_{T}) denote a length T input sequence, and let y_{1:U}=(y₁, y₂, . . . , y_{U}) denote an output target sequence. The transducer model monotonically maps x_{1:U} to y_{0:U}, where y₀=(bos) is the beginning of sentence (bos) token. During frame synchronization-based decoding, every xₜ can generate one or multiple tokens. Such mappings α=[(tᵢ, uᵢ)]_{1<i<U+T} between x_{1:T} and you can be referred to as alignments, where tᵢ ∈ [1, T] and uᵢ ∈ [0, U].

Each vertical arrow in the lattice 400 of FIG. 4 denotes a new token generation. If no token is generated at xₜ, a blank token Ø is assigned. For example, as shown in FIG. 4, there are two consecutive horizontal arrows from step 2 to step 4, so a blank token Ø is assigned to x₃ in this example. The transducer reduces or minimizes condition probability Pᵣ(y|x) by marginalizing all possible alignment paths. In various embodiments, this can be performed using a forward-backward algorithm. For instance, the forward variable α(t, u) is the probability of generating y_{1:u} at step t from the beginning. This can be represented as follows.

$$α ( t , u ) = α ( t - 1 , u ) ∅ ( t - 1 , u ) + α ( t , u - 1 ) y ( t , u - 1 )$$

Here, α(1,0)=1, y(t, u)=Pᵣ(y_{U+1}|t, u) is the emitting probability from token u at time t to generate token u+1 (vertical movement in the lattice from FIG. 4). Ø(t, u)=Pᵣ(yᵤ|t, u) is the corresponding emitting probability for blank token at u and t (horizontal movement from step t to t+1 in FIG. 4). The corresponding backward variable β(t, u) is the probability of sequence y_{U+1:U}: u from time t to the end of the utterance. This can be represented as follows.

$$β ( t , u ) = β ( t + 1 , u ) ∅ ( t , u ) + β ( t , u + 1 ) y ( t , u )$$

Here, β(T,U)=Ø(T, U). The overall probability of sequence y_{0:u} at x_{1:T} is Pᵣ(y|x)=α(T,U) Ø(T,U).

Although FIG. 4 illustrates one example of a transducer decoding lattice 400, various changes may be made to FIG. 4. For example, although a certain number of inputs in the input sequence and outputs in the output sequence are shown, it will be understood that any number of inputs and outputs could be used.

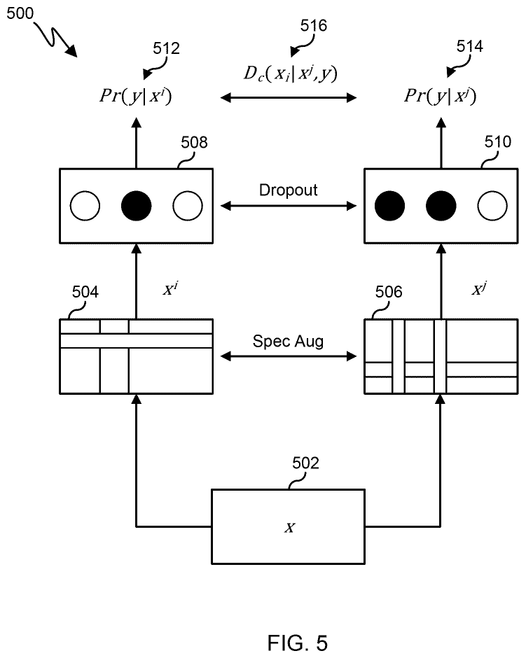

FIG. 5 illustrates an example transducer model training process 500 in accordance with this disclosure. For ease of explanation, the process 500 is described as involving the use of the electronic device 101 in the network configuration 100 of FIG. 1. However, the process 500 may be used with any other suitable electronic device (such as the server 106) or a combination of devices (such as the electronic device 101 and the server 106) and in any other suitable system(s).

As shown in FIG. 5, a training dataset 502 is provided for use in training a transducer model, such as the transducer model 202. The training dataset 502, as also described with respect to FIG. 3, can include audio recordings and corresponding subword unit transcriptions. As shown in FIG. 5, multiple (such as two) copies of the training dataset 502 are created. Augmentation is performed on the copies, such as by adding random noise to the audio frames, to generate a first augmented training dataset 504 (x′) and a second augmented training dataset 506 (x)). These versions or views are provided to the transducer model. The transducer model performs dropout operations on the first and second augmented datasets 504, 506 and calculates the likelihood of various alignments between the audio frames and the transcriptions to provide a first probability distribution 508 and a second probability distribution 510.

Divergence loss, such as KL divergence, is used to identify a first divergence loss 512 associated with the first probability distribution 508 and the first augmented training dataset 504 and a second divergence loss 514 associated with the second probability distribution 510 and the second augmented training dataset 506. The first divergence loss can be represented as Pᵣ(y|xⁱ), and the second divergence loss can be represented as Pᵣ(y|x^{j}). The first and second divergence losses 512, 514 are used to ensure that predictions made by the transducer model are similar for both copies of the training dataset 502. The first and second divergence losses 512, 514 are used to determine a transducer consistency regularization (TCR) loss. The TCR loss is a weighted sum of the divergence loss between the first augmented training dataset 504 and the second augmented training dataset 506. The weights are calculated based on the transducer's occupational probability. The occupational probability is obtained during gradient calculation and can be used to perform a weighted sum on the divergence loss.

In some embodiments, the TCR loss can be represented as follows.

$${D}_{c} ( {x}^{i} \vert {x}^{j} , y ) = {β}_{\overline{∅}} \frac{{\sum }_{t , u} {\overline{ω}}_{∅} ( t , u ) {D}_{KL} ( {y}_{u + 1} , t , u , {x}^{i} , {x}^{j} )}{{\sum }_{t , u} {\overline{ω}}_{∅} ( t , u )} + {β}_{∅} \frac{{\sum }_{t , u} {{ω}^{}}_{∅} ( t , u ) {D}_{KL} ( {y}_{u} , t , u , {x}^{i} , {x}^{j} )}{{\sum }_{t , u} {{ω}^{}}_{∅} ( t , u )}$$

Here, βø and βø are weights for non-blank token and blank token consistency regularization, respectively. Also, D_{KL}(y_{U+1}, t, u, xⁱ, x^{j}) (or D_{KL} (yurt, u, xⁱ, x^{j}) is the KL divergence between distributions y(t, u) (or Ø(t, u)) from data views i and j. Further, ω̅ø and ωø are the occupational probability at time t and symbol u. That is, the TCR loss is based on the forward and backward probability to reach t, u, which can be represented as follows.

$${\overline{ω}}_{∅} ( t , u ) = \frac{α ( t , u ) β ( t , u + 1 ) y ( t , u )}{{P}_{r} ( {y}^{*} \vert x )}$$

$${{ω}^{}}_{∅} ( t , u ) = \frac{α ( t , u ) β ( t + 1 ) ∅ ( t , u )}{{P}_{r} ( {y}^{*} \vert x )}$$

By using a weighted sum, how much each part of the prediction contributes to the overall result can be adjusted. For instance, if an area of the probability distribution has a high likelihood of being occupied, its contribution to the final result can be set to be greater. On the other hand, if an area of the probability distribution has a low likelihood of being occupied, its contribution can be set to be smaller, such as described with respect to FIG. 4. A total loss for the transducer model can be composed of the transducer loss plus the TCR loss. The total loss can be represented as follows.

$$ℒ = - {\sum }_{( x , y )} {\sum }_{i ∈ [ 1 , 2 ]} ln {P}_{r} ( y \vert {x}^{i} ) - λ {D}_{c} ( {x}^{j} \vert {x}^{i} , y )$$

The parameters, such as weights, of the transducer model can be adjusted based on the transducer loss during training to provide a modified and trained transducer model for use in applications such as speech-to-text applications. In some cases, a transducer output may be four-dimensional and include dimensions (B, T, U, D), where B is the batch size, T is the input sequence length, U is the output target sequence length, and D is the total number of tokens. As described with respect to the lattice 400 of FIG. 4, most of the paths from α(0,0) to α(T, U) in the decoding lattice for the transducer may be implausible. For example, as shown in FIG. 4, a diagonal path through the lattice may be the most plausible, while paths outside the diagonal portion are less plausible. A pruned region including the most plausible paths can thus be determined using the transducer model. A resulting occupational probability can be used to select pruning bounds such that most of the joint output occupational probability mass is retained. The final pruned transducer output thus becomes (B, T, S, D), where S is a constant number and Sᵢᵢ U. In the U dimension, the pruned region is defined by pₜ<u<pₜ+S, where pₜ is the lower bound at time t. Thus, the calculation of the lower bound such that the pruned region maximizes the occupational probability can be represented as follows.

$${p}_{t} = {argmax}_{p = 0}^{U - S + 1} ( - {y}^{′} ( t , p - 1 ) + {\sum }_{u = p}^{p + S - 1} ∅ ( t , u ) )$$

Here, y′(t, u) is the derivatives of Lₜₒₜ with respect to y(t, u), and Ø(t, u) is the derivative of Lₜₒₜ with respect to Ø(t, u), where total loss can also be defined by Lₜₒₜ=α(T−1, U)+Ø(T−1, U).

In some embodiments, as an alternative to using a weighted sum for the divergence losses, a hard cutoff of which region to contribute to the final TCR loss can be used. For example, regions with emission probability less than a certain threshold may not contribute to the final TCR loss, such as regions outside the diagonal areas of the probability distribution like is described with respect to FIG. 4.

Although FIG. 5 illustrates one example of a transducer model training process 500, various changes may be made to FIG. 5. For example, while shown as a series of steps, various steps in FIG. 5 could overlap, occur in parallel, occur in a different order, or occur any number of times (including zero times).

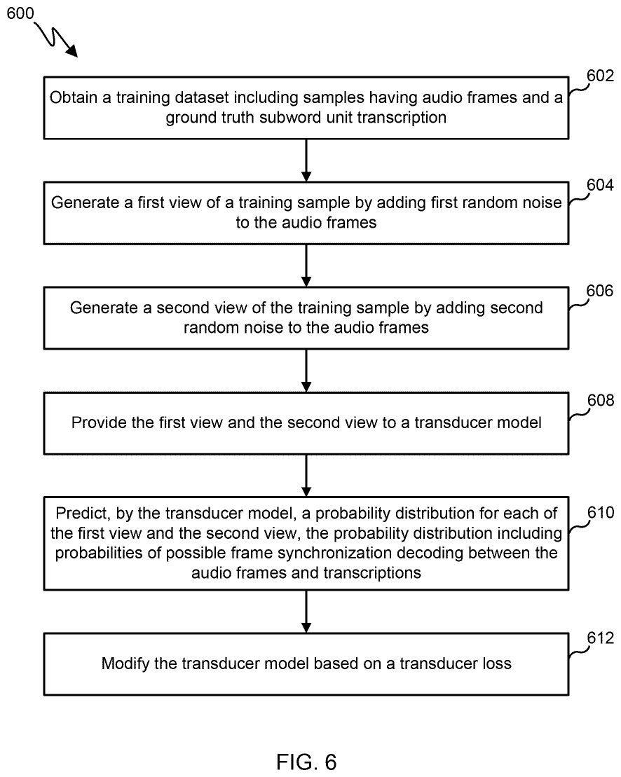

FIG. 6 illustrates an example method 600 for training a transducer model in accordance with this disclosure. For ease of explanation, the method 600 shown in FIG. 6 is described as being performed using the electronic device 101 in the network configuration 100 of FIG. 1. However, the method 600 could be performed using any other suitable device(s), such as the server 106, and in any other suitable system(s).

At step 602, a training dataset is obtained that includes samples having audio frames and a ground truth subword unit transcription. The training dataset can be, for example, the training dataset 502. At step 604, a first view of a training sample is generated by adding first random noise to the audio frames. At step 606, a second view of the training sample is generated by adding second random noise to the audio frames. The first and second views can be the first and second augmented training datasets 504, 506. Note that additional views may or may not be generated here.

At step 608, the first view and the second view are provided to a transducer model, such as the transducer model 202. As described in this disclosure, the transducer model can include an encoder, a predictor, and a joiner. The encoder encodes the audio input into an audio feature vector, the predictor receives previous tokens to predict a subsequent token, and the joiner combines the audio feature vector and the subsequent token to output the probability distribution.

At step 610, the transducer model predicts a probability distribution for each of the first view and the second view. The probability distribution includes probabilities of possible frame synchronization decoding between the audio frames and transcriptions in the first and second views. In various embodiments, each possible frame synchronization decoding corresponds to a sequence of token predictions for the audio frames, and a token prediction for a given audio frame is either a transcript token or a blank token.

At step 612, the transducer model is modified based on a transducer loss, such as described in this disclosure with respect to FIG. 5. For example, in various embodiments, the transducer model can be modified based on the transducer loss via an application of a first transducer divergence loss, where the first view is treated as a teacher and the second view is treated as a student. The transducer model can also be modified based on the transducer loss via an application of a second transducer divergence loss, where the second view is used as the teacher and the first view is used as the student. In various embodiments, a weighted sum of the first transducer divergence loss and the second transducer divergence loss can be used during training, and weights of the weighted sum can be dependent upon how much each probability distribution contributes to the transducer loss.

Although FIG. 6 illustrates one example of a method 600 for training a transducer model, various changes may be made to FIG. 6. For example, while shown as a series of steps, various steps in FIG. 6 could overlap, occur in parallel, occur in a different order, or occur any number of times (including zero times).

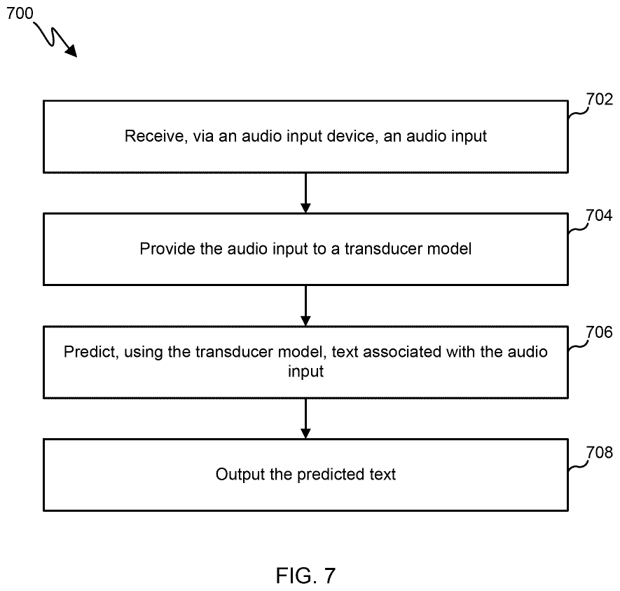

FIG. 7 illustrates an example method 700 for performing a speech-to-text task using a transducer model in accordance with this disclosure. For case of explanation, the method 700 shown in FIG. 7 is described as being performed using the electronic device 101 in the network configuration 100 of FIG. 1. However, the method 700 could be performed using any other suitable device(s), such as the server 106, and in any other suitable system(s).

At step 702, an audio input device, an audio input is received such as via an audio input device like the audio input device 206. At step 704, the audio input is provided to a transducer model, such as the transducer model 202. At step 706, the transducer model is used to predict text associated with the audio input. For example, as described in this disclosure, the transducer model can include an encoder, a predictor, and a joiner. The encoder encodes the audio input into an audio feature vector, the predictor receives previous tokens to predict a subsequent token, and the joiner combines the audio feature vector and the subsequent token to output the probability distribution.

At step 708, the predicted text is output by the transducer model and can be used by the electronic device in various further tasks. For example, the audio input may include commands to the electronic device to perform a task such as performing a search on the Internet, initiating a communication such as a voice or video call to a contact, setting a timer, storing the text for later use, such as in a personal note, conducting an ongoing conversational machine learning process, etc. It will be understood that any task using the text may be performed. It will also be understood that the transducer model can assist with performing text-to-speech as well, as described in this disclosure.

Although FIG. 7 illustrates one example of a method 700 for performing a speech-to-text task using a transducer model, various changes may be made to FIG. 7. For example, while shown as a series of steps, various steps in FIG. 7 could overlap, occur in parallel, occur in a different order, or occur any number of times (including zero times).

It should be noted that the functions shown in FIGS. 2 through 7 or described above can be implemented in an electronic device 101, 102, 104, server 106, or other device(s) in any suitable manner. For example, in some embodiments, at least some of the functions shown in FIGS. 2 through 7 or described above can be implemented or supported using one or more software applications or other software instructions that are executed by the processor 120 of the electronic device 101, 102, 104, server 106, or other device(s). In other embodiments, at least some of the functions shown in FIGS. 2 through 7 or described above can be implemented or supported using dedicated hardware components. In general, the functions shown in FIGS. 2 through 7 or described above can be performed using any suitable hardware or any suitable combination of hardware and software/firmware instructions. Also, the functions shown in FIGS. 2 through 7 or described above can be performed by a single device or by multiple devices. For instance, the server 106 might be used to train one or more machine learning models such as the transducer model 202, and the server 106 could deploy the trained machine learning model(s) to one or more other devices (such as the electronic device 101) for use.

Although this disclosure has been described with reference to various example embodiments, various changes and modifications may be suggested to one skilled in the art. It is intended that this disclosure encompass such changes and modifications as fall within the scope of the appended claims.

What is claimed is:

1. A method comprising:
receiving, via an audio input device, an audio input;
providing the audio input to a transducer model;
predicting, using the transducer model, text associated with the audio input; and
outputting the predicted text;
wherein:
the transducer model is trained using a training dataset, samples in the training dataset including audio frames and a ground truth subword unit transcription;
a first view of a training sample is generated by adding first random noise to the audio frames;
a second view of the training sample is generated by adding second random noise to the audio frames;
the first view and the second view are provided to the transducer model;
the transducer model predicts a probability distribution for each of the first view and the second view, the probability distribution including probabilities of possible frame synchronization decoding between the audio frames and transcriptions; and
the transducer model is modified based on a transducer loss.

2. The method of claim 1, wherein:
the transducer model is modified based on the transducer loss via an application of a first transducer divergence loss, wherein the first view is treated as a teacher and the second view is treated as a student; and
the transducer model is modified based on the transducer loss via an application of a second transducer divergence loss, wherein the second view is used as the teacher and the first view is used as the student.

3. The method of claim 2, wherein:
each possible frame synchronization decoding corresponds to a sequence of token predictions for the audio frames; and
a token prediction for a given audio frame is either a transcript token or a blank token.

4. The method of claim 2, wherein:
a weighted sum of the first transducer divergence loss and the second transducer divergence loss is used during training; and
weights of the weighted sum are dependent upon how much each probability distribution contributes to the transducer loss.

5. The method of claim 1, wherein the transducer model includes an encoder, a predictor, and a joiner.

6. The method of claim 5, wherein the encoder encodes the audio input into an audio feature vector.

7. The method of claim 6, wherein the predictor receives previous tokens to predict a subsequent token.

8. The method of claim 7, wherein the joiner combines the audio feature vector and the subsequent token to output the probability distribution.

9. An electronic device comprising:
at least one processing device configured to:
receive, via an audio input device, an audio input;
provide the audio input to a transducer model;
predict, using the transducer model, text associated with the audio input; and
output the predicted text;
wherein:
the transducer model is trained using a training dataset, samples in the training dataset including audio frames and a ground truth subword unit transcription;
a first view of a training sample is generated by adding first random noise to the audio frames;
a second view of the training sample is generated by adding second random noise to the audio frames;
the first view and the second view are provided to the transducer model;
the transducer model predicts a probability distribution for each of the first view and the second view, the probability distribution including probabilities of possible frame synchronization decoding between the audio frames and transcriptions; and
the transducer model is modified based on a transducer loss.

10. The electronic device of claim 9, wherein:
the transducer model is modified based on the transducer loss via an application of a first transducer divergence loss, wherein the first view is treated as a teacher and the second view is treated as a student; and
the transducer model is modified based on the transducer loss via an application of a second transducer divergence loss, wherein the second view is used as the teacher and the first view is used as the student.

11. The electronic device of claim 10, wherein:
each possible frame synchronization decoding corresponds to a sequence of token predictions for the audio frames; and
a token prediction for a given audio frame is either a transcript token or a blank token.

12. The electronic device of claim 10, wherein:
a weighted sum of the first transducer divergence loss and the second transducer divergence loss is used during training; and
weights of the weighted sum are dependent upon how much each probability distribution contributes to the transducer loss.

13. The electronic device of claim 9, wherein the transducer model includes an encoder, a predictor, and a joiner.

14. The electronic device of claim 13, wherein the encoder is configured to encode the audio input into an audio feature vector.

15. The electronic device of claim 14, wherein the predictor is configured to receive previous tokens and predict a subsequent token.

16. The electronic device of claim 15, wherein the joiner is configured to combine the audio feature vector and the subsequent token to output the probability distribution.

17. A non-transitory machine-readable medium comprising instructions that when executed by at least one processor cause an electronic device to:
receive, via an audio input device, an audio input;
provide the audio input to a transducer model;
predict, using the transducer model, text associated with the audio input; and
output the predicted text;
wherein:
the transducer model is trained using a training dataset, samples in the training dataset including audio frames and a ground truth subword unit transcription;
a first view of a training sample is generated by adding first random noise to the audio frames;
a second view of the training sample is generated by adding second random noise to the audio frames;
the first view and the second view are provided to the transducer model;
the transducer model predicts a probability distribution for each of the first view and the second view, the probability distribution including probabilities of possible frame synchronization decoding between the audio frames and transcriptions; and
the transducer model is modified based on a transducer loss.

18. The non-transitory machine-readable medium of claim 17, wherein:
the transducer model is modified based on the transducer loss via an application of a first transducer divergence loss, wherein the first view is treated as a teacher and the second view is treated as a student; and
the transducer model is modified based on the transducer loss via an application of a second transducer divergence loss, wherein the second view is used as the teacher and the first view is used as the student.

19. The non-transitory machine-readable medium of claim 18, wherein:
a weighted sum of the first transducer divergence loss and the second transducer divergence loss is used during training; and
weights of the weighted sum are dependent upon how much each probability distribution contributes to the transducer loss.

20. The non-transitory machine-readable medium of claim 17, wherein:
the transducer model includes an encoder, a predictor, and a joiner;
the encoder is configured to encode the audio input into an audio feature vector;
the predictor is configured to receive previous tokens and predict a subsequent token; and
the joiner is configured to combine the audio feature vector and the subsequent token to output the probability distribution.
